(19) United States
(12) Patent Application Publication
(10) Pub. No.: US 2009/0069513 A1
(43) Pub. Date: Mar. 12, 2009

(54) EPOXY RESIN, METHOD FOR PRODUCING SAME AND USE THEREOF

(75) Inventors: Masataka Nakanishi, Tokyo (JP); Takao Sunaga, Tokyo (JP)

Correspondence Address: DARBY & DARBY P.C., P.O. BOX 770, Church Street Station, New York, NY, 10008-0770, US

(73) Assignee: Nippon Kayaku Kabushiki Kaisha, Tokyo (JP)

(21) Appl. No.: 11/913,442

(22) PCT Filed: May 9, 2006
(86) PCT No.: PCT/JP2006/309289

§ 371 Date: Nov. 2, 2007

(30) Foreign Application Priority Data
May 9, 2005 (JP) 2005-135813

(51) Int. Cl. C08L 63/00; C08G 59/02; C08G 59/04

(52) U.S. Cl. 525/523; 528/405

(57) ABSTRACT

An object of the present invention is to provide a multifunctional epoxy resin that is in a liquid state and that has a multifunctional structure. The multifunctional epoxy resin can be used as a reactive diluent and also used for a wide range of applications such as a molding material, a casting material, a laminating material, a paint, an adhesive, and a resist. The epoxy resin of the present invention is produced by glycidylation of dipentaerythritol represented by formula (1):

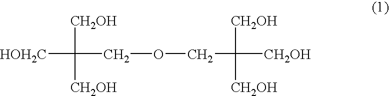

wherein, in the number of moles of a hexafunctional compound (HG) and the number of moles of a pentafunctional compound (LG) in the epoxy resin, the ratio of the number of moles of (HG) to the total number of moles of (HG) and (LG), namely HG/(HG+LG), is in the range of 0.05 to 0.9.

### TECHNICAL FIELD

The present invention relates to a novel multifunctional liquid epoxy resin, a method of producing the same, and use thereof.

### BACKGROUND ART

Liquid epoxy compounds are used as binders for various applications because of their high solvent-solubility and mechanical properties. Typical examples of liquid epoxy resins include ethylene glycol glycidyl ether, propylene glycol glycidyl ether, glycerin glycidyl ether, trimethylolpropane glycidyl ether, cyclohexanedimethanol glycidyl ether, and resins produced by glycidylation of, for example, an aliphatic alcohol such as cyclohexanedimethanol. Liquid compounds having aromatic structures, e.g., bisphenol A-type epoxy resins and resorcin-type epoxy resins, have also been reported.

In general, examples of liquid epoxy resins mainly include low-molecular-weight bifunctional epoxy resins. However, regarding epoxy resins prepared from an aliphatic alcohol, for example, glycidyl ether compounds of multifunctional hydroxyalkanes, such as glycerin glycidyl ether and trimethylolpropane glycidyl ether are liquid, have three or more functional groups involved with curing, and form a three-dimensional structure. These glycidyl ether compounds are used as reactive diluents that provide satisfactory heat resistance and mechanical properties.

However, multifunctional structures that can realize further improvements in heat resistance and mechanical properties, more specifically, glycidyl ether compounds of hydroxyalkanes having four or more functional groups have been desired (Patent Document 1). Dipentaerythritol hexaglycidyl ether is disclosed in Patent Document 3 as an example of such a glycidyl ether compound.

Accordingly, it is desirable that a liquid epoxy resin have a multifunctional structure relating to cross-linking by curing, which affects heat resistance and mechanical properties, while maintaining the dilution effect due to a liquid state. From this point of view, there are very few reports of a multifunctional liquid epoxy resin that is in a liquid state at room temperature. Although such an epoxy resin has been reported, the epoxy resin is synthesized by a method requiring a multistep reaction including, for example, oxidation of an olefin (Patent Document 2).

### Patent Document 1: Japanese Unexamined Patent Application Publication No. 2004-231787

### Patent Document 2: Japanese Unexamined Patent Application Publication No. 2003-246835

### Patent Document 3: Japanese Unexamined Patent Application Publication No. 2003-128838

### DISCLOSURE OF INVENTION

### Problems to be Solved by the Invention

From the above point of view, it is an object of the present invention to provide an epoxy resin that is in a liquid state and that has a multifunctional structure, the epoxy resin capable of being used for various applications.

### Means for Solving the Problems

As a result of intensive studies to solve the above problems, the present inventors have been made the present invention. More specifically, the present invention relates to the following items:

(1) An epoxy resin produced by glycidylation of dipentaerythritol represented by formula (I):

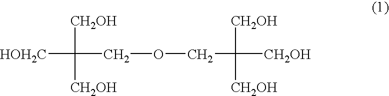

wherein, in the number of moles of a hexafunctional compound (HG) and the number of moles of a pentafunctional compound (LG) in the epoxy resin, the ratio of the number of moles of (HG) to the total number of moles of (HG) and (LG), namely HG/(HG+LG), is in the range of 0.05 to 0.9.
(2) The epoxy resin according to Item (1), wherein the epoxy equivalent of the epoxy resin is in the range of 100 to 150 g/eq.
(3) A method of producing an epoxy resin including allowing dipentaerythritol represented by formula (I):

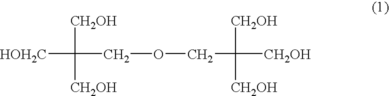

to react with an epihalohydrin in the presence of an alkali metal hydroxide, wherein at least one compound selected from the group consisting of aprotic polar solvents, quaternary ammonium salts, and quaternary phosphonium salts is used as a reaction activator.
(4) The method of producing an epoxy resin according to Item (3), wherein the reaction activator is an aprotic polar solvent, the ratio of the epihalohydrin to the aprotic polar solvent satisfies 0.5≦(epihalohydrin)/(aprotic polar solvent)≦4, and the reaction temperature is 40° C. or higher.
(5) The method of producing an epoxy resin according to Item (3), wherein the reaction activator is a quaternary ammonium salt or a quaternary phosphonium salt, and a secondary or tertiary alcohol is used as a reaction solvent.
(6) An epoxy resin composition containing the epoxy resin according to Item (1) or (2) and a curing agent.
(7) A cured product produced by curing the epoxy resin composition according to Item (6).

### ADVANTAGES OF THE INVENTION

Since an epoxy resin of the present invention contains a hexafunctional multifunctional epoxy resin as a main component and is in a liquid state at room temperature, this resin is useful as a liquid epoxy resin for various applications.

For example, an epoxy resin composition containing the epoxy resin of the present invention can be used for a wide range of applications, for example, a molding material, a casting material, a laminating material, a paint, an adhesive, and a resist.

### BEST MODE FOR CARRYING OUT THE INVENTION

An epoxy resin of the present invention is produced by glycidylation of dipentaerythritol represented by formula (I):

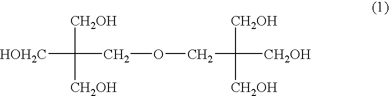

An example of the method of glycidylation is a generally known reaction between a compound having a hydroxyl group and an epihalohydrin. However, since the reactivity of an alcoholic hydroxyl group with an epihalohydrin is low, it is necessary to increase the amount of an alkali metal hydroxide used as a catalyst or to increase the reaction temperature. In order to prevent such a decrease in operational efficiency, in the reaction of dipentaerythritol with an epihalohydrin coexisting with an alkali metal hydroxide, at least one compound selected from the group consisting of aprotic polar solvents, quaternary ammonium salts, and quaternary phosphonium salts is preferably used as a reaction activator.

In this reaction, the alkali metal hydroxide may be used in the form of a solid thereof or in the form of an aqueous solution. When an aqueous solution of the alkali metal hydroxide is used, the following method may be employed: The aqueous solution of the alkali metal hydroxide is continuously added to the reaction system while water and the epihalohydrin are continuously discharged under reduced pressure or atmospheric pressure. Furthermore, the discharged solution is separated so that water is removed and the epihalohydrin is continuously returned to the reaction system. The amount of alkali metal hydroxide used is generally in the range of 1.1 to 20 moles, and preferably in the range of 1.4 to 10.0 moles relative to 1 equivalent of the hydroxyl group of the compound represented by formula (I).

The amount of epihalohydrin used is generally in the range of 0.8 to 20 moles, preferably in the range of 0.9 to 11 moles relative to 1 mole of the hydroxyl group of the compound represented by formula (I).

The reaction activator used in the present invention is a solvent, such as an aprotic polar solvent, that contributes to an improvement in the electrophilicity of the epihalohydrin by means of the salvation therewith, or a substance, such as a quaternary ammonium salt or a quaternary phosphonium salt, that coordinates with the epihalohydrin and that similarly contributes to an improvement in the electrophilicity of the epihalohydrin, thus promoting the progression of the reaction.

Examples of the aprotic polar solvents include dimethyl sulfone, dimethyl sulfoxide, tetrahydrofuran, and dioxane. The amount of aprotic polar solvent used is not particularly limited as long as the reaction is carried out. In general, however, the amount of aprotic polar solvent used is represented by 0.5≦(epihalohydrin)/(aprotic polar solvent)≦4, and preferably 0.5≦(epihalohydrin)/(aprotic polar solvent)≦2.0. When the ratio represented by (epihalohydrin)/(aprotic polar solvent) exceeds 4, the reaction system may gelate.

Examples of the quaternary ammonium salts include tetraalkylammonium halides such as tetramethylammonium chloride and tetramethylammonium bromide, and trimethylbenzylammonium chloride. Examples of the quaternary phosphonium salts include alkyltriphenylphosphonium salts. More specifically, quaternary salts such as a chloride, a bromide, an iodide, or an acetate of benzyltriphenylphosphonium or ethyltriphenylphosphonium can be used.

A quaternary ammonium salt and a quaternary phosphonium salt may be used in combinations. Two or more types of quaternary ammonium salts and/or two or more types of quaternary phosphonium salts may also be used in combinations. The total amount of quaternary ammonium salts and quaternary phosphonium salts used is generally in the range of 0.1 to 15 parts by weight, preferably in the range of 0.2 to 10 parts by weight relative to 1 mole of the hydroxyl group of the compound represented by formula (I).

The aprotic polar solvent functions not only as a reaction activator but also as a solvent for increasing the solubility of the compound represented by formula (I). When a quaternary ammonium salt or a quaternary phosphonium salt is used as the reaction activator, an aprotic polar solvent is preferably used in combination because the reaction is carried out under a milder condition. When a quaternary ammonium salt or a quaternary phosphonium salt is used as the reaction activator, the reaction is preferably conducted using a secondary alcohol such as isopropyl alcohol or a tertiary alcohol such as tert-butyl alcohol as a reaction solvent.

When an alcohol is used, the amount of alcohol used is generally represented by 0.5≦(epihalohydrin)/(alcohol)≦10, and preferably 1≦(epihalohydrin)/(alcohol)≦5.

The reaction temperature is generally in the range of 30° C. to 90° C., preferably in the range of 35° C. to 80° C. When an aprotic polar solvent is used as the reaction activator, the reaction is preferably conducted at a reaction temperature of 40° C. or higher, preferably in the range of 40° C. to 90° C. The reaction time is generally in the range of 0.5 to 10 hours, and preferably in the range of 1 to 8 hours.

After the completion of the reaction, the epihalohydrin, the solvent, and the like are removed by heating under reduced pressure after the reaction product of the epoxidation reaction is washed with water, or without washing the reaction product with water. In addition, in order to produce an epoxy resin containing a smaller amount of hydrolyzable halogen, the recovered epoxy resin may be dissolved in a solvent such as toluene or methyl isobutyl ketone, an aqueous solution of an alkali metal hydroxide such as sodium hydroxide or potassium hydroxide may then be added to the solution to conduct a reaction. Thus, cyclization can be ensured. In this case, the amount of alkali metal hydroxide used is generally in the range of 0.01 to 0.3 moles, and preferably in the range of 0.05 to 0.2 moles relative to 1 mole of the hydroxyl group of the compound represented by formula (I) used in epoxidation. The reaction temperature is generally in the range of 50° C. to 120° C., and the reaction time is generally in the range of 0.5 to 2 hours.

After the completion of the reaction, the resulting salt is removed by, for example, filtration or washing with water. Furthermore, the solvent is distilled off by heating under reduced pressure, thus allowing an epoxy resin of the present invention to be prepared.

The epoxy resin of the present invention contains, as a main component, a compound in which six or five alcoholic hydroxyl groups of the compound represented by formula (I) is subjected to glycidyl etherification. The epoxy resin of the present invention also includes compounds composed of such molecules bonded with bonds produced by opening some of the glycidyl groups. More specifically, the epoxy resin of the present invention is characterized in that, in the number of moles of a hexafunctional compound (HG) and the number of moles of a pentafunctional compound (LG) in the epoxy resin, the ratio of the number of moles of (HG) to the total number of moles of (HG) and (LG), namely HG/(HG+LG), is in the range of 0.05 to 0.9. In the epoxy resin of the present invention, the ratio HG/(HG+LG) is preferably in the range of 0.2 to 0.8, and particularly preferably in the range of 0.3 to 0.8.

As described above, in the epoxy resin of the present invention, a compound, such as the pentafunctional compound, in which some of the alcoholic hydroxyl groups are not subjected to glycidylation and remain in the form of hydroxyl groups is preferably contained in a certain ratio. When the ratio HG/(HG+LG) is more than 0.9, adhesiveness and toughness of the epoxy resin are adversely affected. However, when the ratio HG/(HG+LG) is less than 0.05, the amount of compound not having an epoxy group is increased, and heat resistance is adversely affected. The ratio HG/(HG+LG) can be controlled by, for example, changing the amount of alkali metal hydroxide added. When the amount of alkali metal hydroxide increases, the ratio HG/(HG+LG) tends to increase. On the other hand, when the amount of alkali metal hydroxide decreases, the ratio HG/(HG+LG) tends to increase. The epoxy resin of the present invention preferably has an epoxy equivalent in the range of 100 to 150 g/eq.

By mixing the epoxy resin of the present invention with a curing agent, an epoxy resin composition of the present invention can be obtained. In the epoxy resin composition of the present invention, the epoxy resin of the present invention may be used alone or in combinations with other epoxy resins. In addition, since the epoxy resin of the present invention also has a characteristic as a reactive diluent, the epoxy resin of the present invention is preferably used in combinations with other epoxy resins, rather than alone. When other epoxy resins are used in combinations, the ratio of the epoxy resin of the present invention to the total epoxy resins is preferably 5 weight percent or more, and in particular, 10 weight percent or more.

Specific examples of the epoxy resins that can be used in combination with the epoxy resin of the present invention include, but are not limited to, polycondensates obtained from bisphenol A, bisphenol F, bisphenol S, fluorene bisphenol, terpene diphenol, 4,4′-biphenol, 2,2′-biphenol, 3,3′,5,5′-tetramethyl-[1,1′-biphenyl]-4,4′-diol, hydroquinone, resorcin, naphthalenediol, tris-(4-hydroxyphenyl)methane, 1,1,2,2-tetrakis(4-hydroxyphenyl)ethane, or a phenolic compound (such as phenol, an alkyl-substituted phenol, naphthol, an alkyl-substituted naphthol, dihydroxybenzene, or dihydroxynaphthalene) and formaldehyde, acetaldehyde, benzaldehyde, p-hydroxybenzaldehyde, o-hydroxybenzaldehyde, p-hydroxyacetophenone, o-hydroxyacetophenone, dicyclopentadiene, furfural, 4,4′-bis(chloromethyl)-1,1′-biphenyl, 4,4′-bis(methoxymethyl)-1,1′-biphenyl, 1,4′-bis(chloromethyl)benzene, or 1,4′-bis(methoxymethyl)benzene; modified products thereof; and solid or liquid epoxy resins such as glycidyl-etherified compounds derived from a halogenated bisphenol, such as tetrabromobisphenol A, or an alcohol; alicyclic epoxy resins; glycidyl amine epoxy resins; and glycidyl ester epoxy resins. These may be used alone or in combinations of two or more resins.

Examples of the curing agent in the epoxy resin composition of the present invention include amine compounds, acid anhydride compounds, amide compounds, and phenolic compounds. Specific examples of the curing agent that can be used include, but are not limited to, diaminodiphenylmethane; diethylenetriamine; triethylenetetramine; diaminodiphenylsulfone; isophoronediamine; dicyandiamide; a polyamide resin synthesized from a dimer of linolenic acid and ethylenediamine; phthalic anhydride; trimellitic anhydride; pyromellitic anhydride; maleic anhydride; tetrahydrophthalic anhydride; methyltetrahydrophthalic anhydride; methylnadic anhydride; hexahydrophthalic anhydride; methylhexahydrophthalic anhydride; polycondensates obtained from bisphenol A, bisphenol F, bisphenol S, fluorene bisphenol, terpene diphenol, 4,4′-biphenol, 2,2′-biphenol, 3,3′,5,5′-tetramethyl-[1,1′-biphenyl]-4,4′-diol, hydroquinone, resorcin, naphthalenediol, tris-(4-hydroxyphenyl)methane, 1,1,2,2-tetrakis(4-hydroxyphenyl)ethane, or a phenolic compound (such as phenol, an alkyl-substituted phenol, naphthol, an alkyl-substituted naphthol, dihydroxybenzene, or dihydroxynaphthalene) and formaldehyde, acetaldehyde, benzaldehyde, p-hydroxybenzaldehyde, o-hydroxybenzaldehyde, p-hydroxyacetophenone, o-hydroxyacetophenone, dicyclopentadiene, furfural, 4,4′-bis(chloromethyl)-1,1′-biphenyl, 4,4′-bis(methoxymethyl)-1,1′-biphenyl, 1,4′-bis(chloromethyl)benzene, or 1,4′-bis(methoxymethyl)benzene; modified products thereof; halogenated bisphenols such as tetrabromobisphenol A; imidazole; BF₃-amine complexes; and guanidine derivatives. These may be used alone or in combinations of two or more compounds.

The amount of curing agent used in the epoxy resin composition of the present invention is preferably in the range of 0.7 to 1.2 equivalents relative to 1 equivalent of the epoxy group of the epoxy resin. When the amount of curing agent is less than 0.7 equivalents or when the amount of curing agent exceeds 1.2 equivalents relative to 1 equivalent of the epoxy group, curing is not completely carried out and satisfactory characteristics of the cured product may not be obtained.

In the use of the above curing agent, a curing accelerator may be used in combinations. Examples of the usable curing accelerator include imidazoles such as 2-methylimidazole, 2-ethylimidazole, 2-phenylimidazole, and 2-ethyl-4-methylimidazole; tertiary amines such as 2-(dimethylaminomethyl)phenol, triethylenediamine, triethanolamine, and 1,8-diazabicyclo(5,4,0)undecene-7; organic phosphines such as triphenylphosphine, diphenylphosphine, and tributylphosphine; metal compounds such as tin octoate; tetrasubstituted phosphonium tetrasubstituted borate such as tetraphenylphosphonium tetraphenylborate and tetraphenylphosphonium ethyltriphenylborate; and tetraphenylborate such as 2-ethyl-4-methylimidazole tetraphenylborate and N-methylmorpholine tetraphenylborate. The curing accelerator is used in an amount in the range of 0.01 to 15 parts by weight relative to 100 parts by weight of the epoxy resin, as needed.

Furthermore, various compounding agents such as an inorganic filler, a silane coupling agent, a mold-releasing agent, and pigments such as carbon black, Phthalocyanine Blue, and Phthalocyanine Green; and various types of thermosetting resins may be added to the epoxy resin compound of the present invention, as needed. Examples of the inorganic filler include, but are not limited to, powders of crystalline silica, fused silica, alumina, zircon, calcium silicate, calcium carbonate, silicon carbide, silicon nitride, boron nitride, zirconia, forsterite, steatite, spinel, titania, talc, a quartz powder, an aluminum powder, graphite, clay, iron oxide, titanium oxide, aluminum nitride, asbestos, mica, glass particles, glass fibers, a glass nonwoven fabric, and carbon fibers; and beads produced by spheroidizing any of these substances. These inorganic fillers may be used alone or in combinations of two or more fillers. When the epoxy resin composition is used for an application of a sealing material of semiconductors, these inorganic fillers are preferably used in an amount in the range of 50 to 90 weight percent of the epoxy resin composition in view of heat resistance, moisture resistance, and mechanical properties of the cured product of the epoxy resin composition, though the amount of inorganic fillers varies in accordance with the application.

Examples of the resin include polybutadiene, modified products thereof, modified products of acrylonitrile copolymers, polyphenylene ether, polystyrene, polyethylene, polyimides, and fluorocarbon polymers. Other examples of the compounding agents include maleimide compounds, cyanate ester compounds, silicone gel, and silicone oil.

The epoxy resin composition of the present invention is produced by homogeneously mixing the above components.

The epoxy resin composition of the present invention can be easily formed into a cured product thereof by a known method. For example, the epoxy resin is sufficiently mixed with a curing agent, and as needed, a curing accelerator, an inorganic filler, a compounding agent, and a thermosetting resin using, for example, an extruder, a kneader, or a roller, according to need, until the mixture becomes homogeneous to prepare an epoxy resin composition of the present invention. The epoxy resin composition is then formed by a melt-casting method, a transfer molding method, an injection molding method, a compression molding method, or the like. Furthermore, the molded article is then heated in the range of 80° C. to 200° C. for 2 to 10 hours to produce a cured product.

The epoxy resin composition of the present invention may contain a solvent in some cases. Such an epoxy resin composition containing a solvent is impregnated into a substrate such as glass fibers, carbon fibers, polyester fibers, polyamide fibers, alumina fibers, or paper, and the substrate is dried by heating to prepare a prepreg. The prepreg is then formed by hot pressing. Thus, a cured product of the epoxy resin composition of the present invention can be obtained from the epoxy resin composition containing a solvent. The content of the solvent of the epoxy resin composition is generally in the range of about 10 to 70 weight percent, and preferably in the range of about 15 to 70 weight percent of the total weight of the epoxy resin composition of the present invention and the solvent. Examples of the solvent include solvents cited in the section of a varnish described below, such as toluene, xylene, acetone, methyl ethyl ketone, and methyl isobutyl ketone.

The epoxy resin composition containing a solvent can also be used as a varnish.

In a varnish including the epoxy resin composition of the present invention (hereinafter referred to as “varnish of the present invention”), components are not particularly limited as long as the varnish of the present invention contains the epoxy resin of the present invention, a curing agent, and a solvent. It is sufficient that the varnish of the present invention is a liquid composition in which the components are homogeneously mixed, and the method of producing the liquid composition is not particularly limited.

Optional components added to the varnish of the present invention are not particularly limited as long as the components do not impair the film-forming property and the adhesiveness of the epoxy resin of the present invention. Preferable examples of the optional components include polymers and epoxy compounds that form a film together with the epoxy resin of the present invention, and additives added thereto. Polymers that are dissolved in a solvent used in the varnish of the present invention are preferably used as the polymers of the optional components. Examples of the solvent used in the varnish of the present invention include γ-butyrolactones; amide solvents such as N-methylpyrrolidone (NMP), N,N-dimethylformamide (DMF), N,N-dimethylacetamide, and N,N-dimethylimidazolidinone; sulfones such as tetramethylene sulfone; ether solvents such as diethylene glycol dimethyl ether, diethylene glycol diethyl ether, propylene glycol monomethyl ether, propylene glycol monomethyl ether monoacetate, and propylene glycol monobutyl ether, preferably, lower alkylene glycol mono- or di-lower alkyl ethers; ketone solvents such as methyl ethyl ketone and methyl isobutyl ketone, preferably di-lower alkyl ketones whose two alkyl groups may be the same or different; and aromatic solvents such as toluene and xylene. These may be used alone or as a mixed solvent containing two or more solvents.

The solid content (i.e., the concentration of components other than the solvent) in the prepared varnish is generally in the range of 10 to 90 weight percent, preferably in the range of 20 to 80 weight percent, and more preferably in the range of 25 to 70 weight percent.

The cured product obtained in the present invention can be used for materials of various electric and electronic components. Examples of the applications of the cured product include general applications for which thermosetting resins are used. Examples thereof include adhesives, paints, coating materials, molding materials (such as a sheet, a film, and an FRP), insulating materials (such as a printed circuit board and a wire coating), sealing materials, materials for optical components, and additives to be added to other resins or the like. Examples of materials for optical use include a sealing material for LEDs, and materials of components used with a liquid crystal display unit, such as a substrate material, an optical waveguide, a prism sheet, a deflecting plate, a retardation film, a viewing-angle correction film, an adhesive, and films for a liquid crystal display, e.g., a polarizer protection film, in the liquid crystal display field. In the field of a color plasma display panel (PDP), which is expected as a next-generation flat panel display, examples of the materials include a sealing material, an antireflection film, an optical correction film, a housing material, a protective film of a front glass, an alternative material for a front glass, and an adhesive. In the field of an LED display unit, examples of the materials include a molding material of LEDs, a sealing material of LEDs, a protective film of a front glass, an alternative material for a front glass, and an adhesive. In the field of a plasma addressed liquid crystal (PALC) display, examples of the materials include a substrate material, an optical waveguide, a prism sheet, a deflecting plate, a retardation film, a viewing-angle correction film, an adhesive, and a polarizer protection film. In the field of an organic electroluminescence (EL) display, examples of the materials include a protective film of a front glass, an alternative material of a front glass, and an adhesive. In the field of a field-emission display (FED), examples of the materials include film substrates, a protective film of a front glass, an alternative material of a front glass, and an adhesive. In the optical recording field, examples of the materials include substrate materials for video discs (VDs), CD/CD-ROM discs, CD-R/RW discs, DVD-R/DVD-RAM discs, MO/MD discs, phase change rewritable discs (PDs), and discs for optical cards; a pick-up lens; a protective film; a sealing material; and an adhesive.

Examples of the materials used in the optical instrument field include materials for a lens of a still camera, a finder prism, a target prism, a finder cover, and a photodetector part. Examples thereof also include materials of a taking lens and a finder for a video camera. Examples thereof also include materials of a projector lens, a protective film, a sealing material, and an adhesive for a projection television. Examples thereof also include a material of a lens, a sealing material, an adhesive, and a material of a film for an optical sensing device. Examples of materials used in the optical component field include a material for a fiber disposed near an optical switch, a lens, a waveguide, a sealing material of an element, and an adhesive in an optical communication system. Examples thereof also include a material of an optical fiber disposed near an optical connector, a ferrule, a sealing material, and an adhesive used therefor. In optical passive components and optical circuit components, examples thereof include materials for a lens, a waveguide, a sealing material of an LED, a sealing material of a CCD, and an adhesive. Examples thereof also include a material of a substrate disposed near an optoelectronic integrated circuit (OEIC), a fiber material, a sealing material of an element, an adhesive used therefor. Examples of the materials used in the optical fiber field include materials of sensors for industrial applications, such as lights and light guides for decorative display; displays and signs; and optical fibers for a communication infrastructure and for connecting to household digital devices. Examples of materials used for producing a semiconductor integrated circuit include resist materials for microphotolithography used for LSI and VLSI materials. Examples of materials used in the field of automobiles and transport machines include materials for a lamp reflector for automobiles, a bearing retainer, a gear portion, a corrosion-resistance coating, a switch portion, a headlight, a component in an engine, an electrical component, interior or exterior components, a drive engine, a brake oil tank, an antirust steel sheet for automobiles, an interior panel, an interior material, a protective or bundling wire, a fuel hose, an automobile lamp, and an alternative material for glass. Double glazing for a railroad vehicle is also included. Examples thereof also include a toughness-imparting agent for a structural material, a component disposed near an engine, a protective or bundling wire, and a corrosion-resistance coating for aircraft. Examples of the material used in the architectural field include a material for interiors and processing, an electrical cover, a sheet, an interlayer for laminated glass, an alternative material for glass, and a material used as a solar cell component. An example of the material used in the agricultural field is a film for covering a plastic house. Examples of optical and electronic functional organic materials of the next generation include materials for an organic EL element, an organic photorefractive element, an optical amplifying element, which is a light-light conversion device, and an optical computing element, and a substrate material used for an organic solar cell, a fiber material, a sealing material of an element, and an adhesive.

Examples of the adhesives include adhesives used in civil engineering, architecture, automobiles, offices, medical care, and electronic materials. Among these, specific examples of the adhesive for electronic materials include an interlayer adhesive of a multilayer substrate such as a built-up substrate; adhesives for semiconductors, such as a die bonding agent and an underfill; and adhesives for mounting, such as an underfill for reinforcing BGAs, an anisotropic conductive film (ACF), and an anisotropic conductive paste (ACP).

Examples of the sealing materials include materials for sealing by potting, dipping, or transfer molding of a capacitor, a transistor, a diode, an IC, an LSI, or the like; materials for sealing by potting of an IC or an LSI mounted by means of COB, COF, and TAB; a material for an underfill for flip-chip or the like; and materials for sealing (including an underfill for reinforcing) in mounting of an IC package, for example, QFB, BGA, or CSP.

### EXAMPLES

The present invention will now be described more specifically using examples. In the description below, the word “parts” means parts by weight unless otherwise stated. The present invention is not limited to these examples. In the examples, the epoxy equivalent and the melt viscosity were measured under the following conditions.

1) Epoxy equivalent: The epoxy equivalent was measured in accordance with the method specified in JIS K-7236.
2) Viscosity at 25° C.: E-type viscometer
3) The contents of a hexafunctional compound and a pentafunctional compound: Gas chromatography-mass spectrometer

### Example 1

First, 53 parts of dipentaerythritol, 578 parts of epichlorohydrin, 578 parts of dimethyl sulfoxide, 6 parts of tetramethylammonium chloride, and 12 parts of water were charged in a flask equipped with a stirrer, a reflux condenser, and a stirring device, and the temperature of the mixture was increased to 50° C. under stirring. Subsequently, 60 parts of flaky sodium hydroxide was added to the reaction mixture little by little over a period of 90 minutes. The reaction mixture was then stirred at 50° C. for two hours and at 70° C. for two hours. After the completion of the reaction, washing was performed with 300 parts of water two times to remove a produced salt and the like. Excessive epichlorohydrin and the like were then distilled off by heating under reduced pressure. Subsequently, 200 parts of methyl isobutyl ketone was added to the residue to dissolve the residue, and the system was maintained at 70° C. Subsequently, 10 parts of a 30% aqueous sodium hydroxide solution was added thereto, and the resulting mixture was heated for one hour. Washing was then performed with 200 parts of water three times. The resulting organic layer was concentrated by heating under reduced pressure. Accordingly, 67 parts of an epoxy resin (EP1) was obtained as a liquid resin. The prepared epoxy resin had a ratio HG/(HG+LG) of 0.7, a viscosity at 25° C. of 1,362 mPa·s, and an epoxy equivalent of 116 g/eq.

### Example 2

First, 46.6 parts of dipentaerythritol, 462 parts of epichlorohydrin, 150 parts of tert-butanol, 5 parts of tetramethylammonium chloride, and 10 parts of water were charged in a flask equipped with a stirrer, a reflux condenser, and a stirring device, and the temperature of the mixture was increased to 80° C. under stirring. The reaction mixture was stirred at 80° C. for one hour, and the temperature in the system was then decreased to 50° C. Subsequently, 60 parts of flaky sodium hydroxide was added to the reaction mixture little by little over a period of 90 minutes. The reaction mixture was then stirred at 50° C. for two hours and at 70° C. for two hours. After the completion of the reaction, washing was performed with 300 parts of water two times to remove a produced salt and the like. Excessive epichlorohydrin and the like were then distilled off by heating under reduced pressure. Subsequently, 200 parts of methyl isobutyl ketone was added to the residue to dissolve the residue, and the system was maintained at 70° C. Subsequently, 10 parts of a 30% aqueous sodium hydroxide solution was added thereto, and the resulting mixture was heated for one hour. Washing was then performed with 200 parts of water three times. The resulting organic layer was concentrated by heating under reduced pressure. Accordingly, 81 parts of an epoxy resin (EP2) was obtained as a liquid resin. The prepared epoxy resin had a ratio HG/(HG+LG) of 0.65, a viscosity at 25° C. of 1,560 mPa·s, and an epoxy equivalent of 127 g/eq.

### Test Example 1

Twelve parts of the epoxy resin (EP1) prepared in Example 1 and 6.6 parts of Kayahard A-A (manufactured by Nippon Kayaku Co., Ltd., amine curing agent) were homogeneously mixed and the mixture was cured at 120° C. for two hours and at 160° C. for five hours. The glass transition temperature and the coefficient of linear expansion were measured as follows using the resulting cured product. The results are shown in Table 1 together with the viscosity of the resin.

Gras transition temperature and coefficient of linear expansion:

Thermomechanical analyzer (TMA): manufactured by Ulvac-Riko, Inc., TM-7000

Temperature-increasing rate: 2° C./min.

### Comparative Example 1

Seventeen parts of a bisphenol F-type epoxy resin (manufactured by Nippon Kayaku Co., Ltd., RE-304S) and 6.6 parts of Kayahard A-A (manufactured by Nippon Kayaku Co., Ltd., amine curing agent) were homogeneously mixed, and the mixture was cured at 120° C. for two hours and at 160° C. for five hours. The results are shown in Table 1. The glass transition temperature and the coefficient of linear expansion of the resulting cured product were measured as in Test Example 1. The results are shown in Table 1.

| | Glass | | | |
|---|---|---|---|---|
| | transition | Coefficient of liner | | Viscosity |
| | temperature | expansion | | 25° C |
| | TMA (° C.) | α1 (ppm) | α2 (ppm) | (mPa · s) |
| Test | 111 | 80.6 | 148.0 | 1,362 |
| Example 1 | | | | |
| Comparative | 120 | 74.7 | 185.8 | 3,000 to 6,000 |
| Example 1 | | | | |

According to the above results, the epoxy resin of the present invention has substantially the same glass transition temperature as that of an aromatic liquid epoxy resin, and thus has a high heat resistance. When the epoxy resin of the present invention is used as a reactive diluent, the glass transition temperature of the composition can be maintained, and in addition, the epoxy resin of the present invention has a low coefficient of linear expansion α2 of about 150 ppm whereas the coefficient of linear expansion α2 of the known epoxy resin is about 180 ppm. Accordingly, the epoxy resin of the present invention is a resin having a low viscosity and has excellent heat resistance.

1. An epoxy resin produced by glycidylation of dipentaerythritol represented by formula (1): 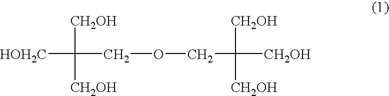
comprising a hexafunctional compound (HG) and a pentafunctional compound (LG), the ratio of the number of moles of (HG) to the total number of moles of (HG) and (LG), namely HG/(HG+LG), is in the range of 0.05 to 0.9 in the epoxy resin.

2. The epoxy resin according to claim 1, wherein the epoxy equivalent of the epoxy resin is in the range of 100 to 150 g/eq.

3. A method of producing an epoxy resin comprising allowing dipentaerythritol represented by formula (1): 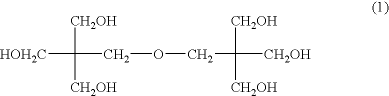
to react with an epihalohydrin in the presence of an alkali metal hydroxide, wherein at least one compound selected from the group consisting of aprotic polar solvents, quaternary ammonium salts, and quaternary phosphonium salts is used as a reaction activator.

4. The method of producing an epoxy resin according to claim 3, wherein the reaction activator is an aprotic polar solvent, the ratio of the epihalohydrin to the aprotic polar solvent satisfies 0.5≦(epihalohydrin)/(aprotic polar solvent)≦4, and the reaction temperature is 40° C. or higher.

5. The method of producing an epoxy resin according to claim 3, wherein the reaction activator is selected from the group consisting of a quaternary ammonium salt and a quaternary phosphonium salt, and a secondary or tertiary alcohol is used as a reaction solvent.

6. An epoxy resin composition comprising the epoxy resin according to claim 1 and a curing agent.

7. A cured product produced by curing the epoxy resin composition according to claim 6.

8. An epoxy resin composition comprising the epoxy resin according to claim 2 and a curing agent.

9. A cured product produced by curing the epoxy resin composition according to claim 8.
